(19) United States
(12) Patent Application Publication
(10) Pub. No.: US 2022/0032313 A1
(43) Pub. Date: Feb. 3, 2022

(54) COMMINUTING APPARATUS WITH COOLING DEVICE AND METHOD OF OPERATING THE SAME

(71) Applicant: VECOPLAN AG, Bad Marienberg (DE)

(72) Inventors: Marcel UDERT, Stockum-Pueschen (DE); Martin BALDUS, Todtenberg (DE)

(21) Appl. No.: 17/443,845

(22) Filed: Jul. 28, 2021

(30) Foreign Application Priority Data
Jul. 28, 2020 (DE) 10 2020 119 889.2

(51) Int. Cl. B02C 25/00; B02C 18/14; B02C 23/18

(52) U.S. Cl. CPC B02C 25/00; B02C 23/18; B02C 18/14

(57) ABSTRACT

A comminuting apparatus adapted to carry out a comminuting process comprising a comminuting rotor which is mounted to a machine frame and which has a plurality of comminuting tools at its periphery, wherein the comminuting rotor is arranged in a comminuting chamber for receiving comminution material and is adapted to comminute the material in the comminuting chamber, further including a cooling device adapted to introduce a liquid coolant including at least 80% water into the comminuting chamber and including a control device for controlling the cooling device to set a rate of introduction of the coolant into the comminuting chamber. The comminuting apparatus according to the invention is distinguished in that the control device is designed and configured to adapt a rate of introduction of the liquid water-based coolant into the comminuting process to an operating parameter of the apparatus, that is dependent on the quantitative throughput of the comminution material, in such a way that more than 60% of the cooling capacity introduced into the comminution material is provided by the latent heat of the liquid water-based coolant. The invention further concerns a method of operating an apparatus.

### FIELD

The invention concerns a comminuting apparatus in which a comminuting rotor is mounted to a machine frame and has a plurality of comminuting tools at its periphery, wherein the comminuting rotor is arranged in a comminuting chamber for receiving comminution material and is adapted to comminute the material in the comminuting chamber, further including a cooling device adapted to introduce a liquid water-based coolant into the comminuting chamber and including a control device for controlling the cooling device to set a rate of introduction of the coolant into the comminuting chamber.

### BACKGROUND

Such comminuting apparatuses are well-known in the art, in particular in the comminution of plastic materials, for example for the exploitative recovery of production residues or recycling of plastic materials. In particular in the processing of plastics, but under some circumstances also in relation to other specific material to be comminuted, cooling of the material during the comminuting process is necessary in order to prevent the process heat which acts on the material to be comminuted in the comminuting process resulting in an excessively high temperature of the material, which under some circumstances hampers the comminuting process itself, that requires the material to be cut, broken and/or torn up, or even causes an unwanted phase transition in respect of the comminution material, which can hamper or totally prevent subsequent further processing of the crushed material.

Such a conventional comminuting apparatus which is adapted to cool the material to be comminuted during the comminuting process is described for example in laid-open specification EP 1 364 713 A2. The teaching there involves using a coolant in the form of a gas like compressed air and/or a liquid like for example cold water in order to carry away the process heat generated and thus to ensure that comminution material temperatures which are not conducive to the comminuting process are not created during the process. Disposal of the used heated coolant is conventionally effected by removal of the comminuted material or by way of a separate apparatus which for example passes the coolant over an external heat exchanger and prepares it in a closed circuit for re-use.

It has been found that the described comminuting apparatuses in accordance with the state of the art, particularly when dealing with thermally sensitive materials, frequently do not provide for adequate removal of the process heat in order to prevent an unwanted change in state or even to prevent the material catching fire during the comminuting operation. In addition, disposal or re-processing of the used heated coolant in apparatuses in the state of the art involves increased equipment-related expenditure and increased maintenance of the comminuting apparatus. Furthermore, in particular with the described conventional water cooling the moisture content of the comminuted material can be increased to such an extent that subsequent further processing of the comminuted material is hampered or results in lower-quality products.

### SUMMARY

The object of the present invention is to at least partially overcome the described disadvantages of conventional comminuting apparatuses in accordance with the state of the art. That object is attained by a comminuting apparatus having the features of claim 1. The comminuting apparatus according to the invention has a comminuting rotor mounted to a machine frame and including at its periphery a plurality of comminuting tools, wherein the comminuting rotor is arranged in a comminuting chamber for receiving comminution material and is adapted to comminute the material disposed in the comminuting chamber, wherein moreover there is provided a cooling device adapted to introduce a liquid coolant which has a water content of at least 80% into the comminuting chamber. Furthermore, the comminuting apparatus according to the invention has a control device for controlling the cooling device for setting a rate of introduction of the coolant into the comminuting chamber. The comminuting apparatus according to the invention is distinguished in that the control device is designed and configured to adapt the rate of introduction of the liquid water-based coolant into the comminuting process or chamber to an operating parameter of the apparatus, that is dependent on the quantitative throughput of the comminution material, in particular a volume throughput, a mass throughput of the comminution material, and/or a drive power of a rotor drive, in particular a drive motor of the rotor drive, in such a way that more than 60% of the cooling capacity introduced into the comminution material is provided by the latent heat of the liquid water-based coolant. The specified quantitative throughput of the comminution material, to which the coolant introduction rate is adapted, can be the quantitative throughput of the material to be comminuted or the quantitative throughput of the comminuted material (ground material).

The comminuting apparatus according to the invention is based on the fundamental idea of designing a cooling device with suitable control in such a way that a liquid water-based coolant is introduced into the comminuting chamber in which the comminuting process takes place and process heat is generated by the comminuting operation, in such a way that the cooling capacity is provided substantially, in particular to a predominant proportion, by the latent heat of the water-based coolant so that effective process heat removal can be implemented with comparatively low coolant input without resulting in increased temperatures of the comminuted material, that can be detrimental to further processing of the comminuted material. As the coolant introduction rate is adapted to the quantitative throughput of the comminution material which is being processed in the comminuting process it is also possible to avoid a moisture content threshold in respect of the comminuted material (ground material), that is possibly predetermined and hampers further processing of the comminuted material, or under some circumstances the moisture content of the comminuted material can be set to be lower than the moisture content of the material fed to the comminuting rotor. In that respect the comminuting apparatus according to the invention is so adapted and controlled that so much coolant is fed into the comminuting process at any time that optimum cooling is afforded and at the same time the coolant is substantially completely expelled from the material during the comminuting operation by the transition into the gaseous phase by evaporation or vaporisation. The described control of the cooling device makes it possible in that respect to avoid an operating situation in which too much coolant is passed into the comminuting chamber, with the result that an increased cooling component is provided by the coolant in the liquid aggregate state and thus a lower degree of conversion of coolant into the vaporous phase takes place.

With the comminuting apparatus designed according to the invention, in an embodiment, in particular thermally sensitive materials, for example plastic panels, can be comminuted to a small grain size, for example <12 mm, in one stage, without subsequent comminution being required, for example in cutting mills. The comminuting apparatus according to the invention can guarantee a high level of process reliability, in addition the level of efficiency of the comminuting apparatus according to the invention can be improved over the conventional comminuting apparatus, and that permits control of the material throughput with the same rotor drive power. The effective cooling of the material to be comminuted, afforded by the comminuting apparatus according to the invention, can result in a reduction in the wear of the comminuting tools on the rotor or counterpart blade or blades fixed to the machine frame, by virtue of the reduced friction and thermal stressing of the components. A further substantial advantage of the comminuting apparatus according to the invention over the comminuting apparatuses of the state of the art can involve the elimination of additional assemblies for disposal of the used heated coolant, in addition the amount of coolant can be greatly reduced with the comminuting apparatus according to the invention.

The expression ‘liquid water-based coolant’ means here a coolant which contains substantially water with a proportion by weight of more than 80%, in particular more than 90%. In particular the coolant can also completely consist of water without any additives. It is however also in accordance with the invention to use a water-based coolant with additives. By way of example a soap additive can be added to the coolant in order to implement a washing operation on the material at the same time as cooling it.

The expression ‘cooling capacity introduced into the comminuting chamber’ or ‘cooling capacity introduced into the comminution material’ can mean the cooling capacity afforded by the coolant, which is received by the material to be comminuted or the comminuted material and thus results in the temperature of the material being reduced.

Further advantageous features and developments of the invention are set forth in the general description hereinafter, the Figures, the specific description and the appendant claims.

Desirably the cooling device or coolant device of the comminuting apparatus according to the invention can include a coolant connection for connection to a coolant network or a water supply main or a coolant reservoir. Insofar as the pressure in the supply mains is sufficient the comminuting apparatus according to the invention for controlling the coolant introduction can include a valve device, with which the rate of introduction of the liquid water-based coolant is controlled. In embodiments of the comminuting apparatus according to the invention in which it includes a coolant reservoir a coolant pump can be included in order to set the specified coolant introduction rate, under some circumstances in conjunction with a valve device, for example by establishing the mass flow or volume flow of the coolant into the comminuting process.

The term ‘comminuting chamber’ can include an introduction chamber for accommodating the material to be comminuted including the structural space of the rotor. In that respect it can also be provided that the comminuting chamber can be altered for example by a supply device like a drivable slider of a feed device, in particular for moving comminution material in the direction towards the comminuting rotor. It can also be provided according to the invention that the material to be comminuted can be introduced into the comminuting chamber by way of a filling hopper, wherein this embodiment can also include a supply device.

It should be noted that the introduction of the liquid water-based coolant into the comminuting process can be implemented continuously or discontinuously, in which respect the term ‘rate of introduction of the coolant’ or ‘throughput amount of the comminution material’ relates to a respective predetermined period of time. That period of time can be for example in the seconds range or also in the minutes range.

In order to ensure that the comminuted material does not exceed a predetermined moisture content or is within a predetermined moisture content range it can be provided with the comminuting apparatus according to the invention that the control device is configured and adapted to carry out adaptation of the coolant introduction rate to the quantitative throughput of the comminution material into the comminuting process in such a way that more than 70% or more than 80%, in particular more than 90% of the introduced coolant, changes from the liquid to the vaporous phase upon cooling of the comminution material or the comminuted material. Accordingly, the control device can be adapted and designed to control the introduction rate in such a way that a predetermined moisture content of the comminuted material is not exceeded or the moisture content of the comminution material lies within a predetermined moisture content range. That upper limit can for example correspond to a processing moisture content which specifies a maximum possible moisture content in the comminuted material, for example a plastic granulate, at which the quality of the semi-finished products or shaped products formed therefrom is still guaranteed. A water content which is usually permissible for the processing of plastics like PE, PB, PA, PET can be at about 0.02 to 0.1 wt. %.

Desirably the comminuting apparatus according to the invention can have at least one moisture sensor for detecting a moisture content of the comminuted material, wherein the control device can be adapted to provide for closed-loop or open-loop control to a predetermined set point moisture content or a predetermined set point moisture range of the comminuted material, with a setting variable establishing the coolant introduction rate. Such a setting variable can include for example an actuation signal for a valve device and/or a coolant pump of the cooling device.

In order to prevent a predetermined temperature of the comminuted material being exceeded when carrying out the comminuting process it can desirably be provided that the comminuting apparatus has at least one temperature-sensor for detecting a temperature of the comminuted or partially comminuted material in the comminuting chamber and/or for detecting a temperature of the comminuted material outside the comminuting chamber, wherein the control device is designed and adapted to provide for open-loop or closed-loop control to a predetermined set point temperature or a predetermined set point temperature range of the comminuted material with a setting variable establishing the coolant introduction rate. In that respect that setting variable can be identical to the above-specified setting variable for the moisture content control of the comminuted material. It is in accordance with the invention that the at least one temperature sensor for detecting the temperature of the comminuted material in the comminuting chamber can be designed and adapted to detect the temperature of the comminuted material in the region of the comminuting process, that is to say in a region of the comminuting apparatus in which the comminuting operation is taking place, for example in the region of the rotor, under some circumstances in the region of counterpart blades arranged stationarily relative to the machine frame, as it is in those regions that comminution of the comminuting material predominantly takes place. For example, in particular with such comminuting apparatus in which a sieve device surrounds the comminuting rotor over a part of its periphery, the at least one temperature sensor can be arranged and adapted to detect the temperature of the comminution material still in the comminuting process, between the sieve and the rotor, that is to say within the comminuting chamber. It is possible that at least one temperature sensor is arranged and adapted to detect the temperature of the comminuted material, that has moved out of the operative region of the comminuting rotor and thus out of the comminuting chamber, for example after the comminuting process, having been guided or having dropped downwardly on to a conveyor belt arranged below the rotor.

As generally the greatest process waste heat is generated in the region of or at a short radial spacing relative to the comminuting tools of the rotor it can desirably be provided that the comminuting apparatus according to the invention has at least one temperature sensor for detecting a temperature at the rotor, in particular a temperature in the region of one or more. comminuting tools, wherein the control device is adapted to provide for closed-loop control to a predetermined set point temperature or a predetermined set point temperature range of the rotor with a setting variable establishing the rate of introduction of the coolant.

It can be provided that in the closed-loop control by setting the rate of introduction of the coolant into the comminuting process or the comminuting chamber it is not just one of the above-specified input variables but a plurality thereof that are involved, in particular the volume throughput of the comminution material, the mass throughput of the comminution material, a temperature of the comminuted material, a temperature of the material to be comminuted, a temperature at the rotor, a moisture content of the comminuted material and/or a moisture content of the material to be comminuted. In particular it can be provided that the closed-loop control as closed loop control variables includes the temperature and the moisture content of the comminuted material and is designed as multi-variable closed-loop control, wherein the respective set point value or set point range of the comminuted material are subjected to closed-loop control with a setting variable establishing the rate of introduction of the coolant.

To provide a setting variable for the closed-loop control the cooling device of the comminuting apparatus according to the invention can include a connecting device for connection to a coolant conduit network and/or for connection to a coolant reservoir and a coolant nozzle device including at least one coolant nozzle for introducing coolant into the comminuting process or the comminuting chamber, wherein the control device for controlling the rate of introduction of the coolant into the comminuting chamber can be adapted to set or actuate at least one flow valve for the coolant and/or at least one coolant pump. Depending on the respective design configuration the setting variable for example can be a control signal for a coolant flow valve or a coolant pump. In regard to the closed-loop control for example the setting variable can be adapted for performing two-point control, that is to say in that case a flow valve or a valve device can be opened or closed or a coolant pump can be switched on or off. It can however also be provided that the setting variable is continuously altered, for example by providing corresponding control signals of the control device in order to adjust the through-flow through the valve or the valve device continuously or to adjust the pump output of the coolant pump continuously. Desirably the comminuting apparatus according to the invention can include a through-flow rate sensor for detecting the coolant introduction rate.

In order to transfer the largest possible proportion of the coolant introduced into the comminuting process or the comminuting chamber into the gaseous phase it can be provided that the coolant is introduced into the comminuting process or comminuting chamber in finely distributed form, in particular in the form of a uniform atomization in order to provide for the lowest possible temperature of the comminuted material and the lowest possible moisture content of the comminuted material. To provide for uniform introduction of the coolant it can desirably be provided that the coolant nozzle device has a plurality of nozzles arranged in spaced relationship with the longitudinal axis of the rotor on the machine frame of the comminuting machine, wherein those nozzles can be arranged above the rotor in the installed position so that the liquid coolant introduced drops under the force of gravity acting thereon in a direction towards the rotor or into a portion of the region of the rotor, in which the respective comminuting process is substantially taking place. It can also be provided that the coolant nozzle device has a plurality of nozzles arranged in spaced relationship with the longitudinal axis of the rotor at the periphery thereof for introduction of the water-based coolant, wherein the nozzles can be oriented in the radial direction relative to the rotor. In both variants it is also possible to use a nozzle device which delivers coolant in the longitudinal direction of the rotor throughout same.

It can be provided that the coolant nozzle device is adapted to apply the coolant to the rotor and/or to the material to be comminuted. By way of example one or more nozzles can be oriented towards the rotor and/or one or more nozzles can be oriented towards the material to be comminuted in the region of the rotor. The term ‘oriented’ means in this respect orientation for delivery of the liquid coolant in a direction towards the rotor or the material to be comminuted or the partially comminuted material.

In order to enhance phase conversion of the coolant by the provision of a large surface area in respect of the coolant introduced it can desirably be provided that the coolant nozzle device is designed and adapted to introduce the water-bearing coolant in the form of a water mist into the comminuting process, in particular on to the rotor and/or the comminuted material in the region of the rotor, wherein the water mist droplets are of a diameter <100 μm, in particular <50 μm. In particular corresponding nozzles for introduction of the liquid coolant can be adapted to atomise the coolant so that this gives the specified droplet size.

In order to prevent the moisture content of the air in the region of the comminuting apparatus according to the invention in operation thereof exceeding a predetermined threshold value it can desirably be provided that the comminuting apparatus has a suction removal device adapted to at least partially suck away the coolant vapor which develops during cooling of the comminuted material, in particular water vapor. Such a measure can be appropriate in particular in relation to a comminuting apparatus according to the invention, which by virtue of the material to be comminuted generates an increased process heat which, as described in relation to the apparatus according to the invention, is discharged substantially by the phase conversion of the coolant.

To optimize the closed-loop control performance in operation of the comminuting apparatus according to the invention it can have at least one moisture sensor for detecting a moisture content of the material to be comminuted, in particular outside the comminuting chamber, wherein the control device can be adapted in dependence thereon as a further closed-loop control variable to provide for closed-loop control of the rate of introduction for the coolant introduced into the comminuting process.

In order to provide for uniform cooling within the comminuting process over the entire working width (axial working length) of the rotor it can desirably be provided that the comminution material is fed to the rotor for example by means of a feed device which operates over the working width of the rotor and the coolant device is adapted, in respect of comminution material arranged over the entire working width of the rotor, to provide for introduction of the coolant, in particular uniform introduction over the working width of the rotor.

The above-specified object is further attained by a method of cooling comminution material and/or comminuted material in a comminuting apparatus adapted to carry out a comminuting process, in which a comminution material disposed in a comminuting chamber of the comminuting apparatus is comminuted by means of comminuting tools mounted to the periphery of a comminuting rotor, wherein during the comminuting operation a liquid water-based coolant including at least 80% water is introduced into the comminuting chamber or the comminuting process taking place in the comminuting chamber. The method according to the invention is distinguished in that a rate of introduction of the coolant into the comminuting process is adapted to an operating parameter of the apparatus, that is dependent on the quantitative throughput of the comminution material, in particular a volume throughput of the comminution material, a mass throughput of the comminution material in the apparatus, and/or a drive power of the rotor drive, in such a way that more than 60% of the cooling capacity introduced into the comminution material is provided by the latent heat of the water-based coolant.

As already explained hereinbefore introduction of the water-containing coolant in the comminuting process or the comminuting chamber can take place continuously or discontinuously, in accordance with the invention in both cases that rate of introduction is adapted to an operating parameter dependent on the quantitative throughput of the comminution material, that is to say the amount of comminuted material.

Depending on the respective design configuration adaptation of the coolant introduction rate can be such that more than 70%, in particular more than 75%, preferably more than 80% of the cooling capacity introduced into the comminution material or into the comminating chamber is provided by the latent heat of the coolant introduced.

In particular to avoid a moisture content in the comminuted material, that hampers subsequent processing thereof, it can desirably be provided that adaptation of the coolant introduction rate to the quantitative throughput of the comminution material into the comminuting process can be such that more than 80%, in particular more than 90% of the introduced coolant transitions from the liquid to the vaporous phase upon cooling of the comminution material or the comminuted material.

To explain adaptation of the introduction rate to the quantitative throughput of the comminution material by the comminuting apparatus according to the invention it will be assumed hereinafter that 100% of the coolant introduced transitions from the liquid into the vaporous phase upon cooling of the comminution material or the comminuted material. It will further be assumed that the temperature T_{Input-Material} of the comminution material introduced into the comminuting chamber is to be identical to the temperature of the comminuted material, that is to say after passing through the comminuting process, under the action of the described cooling. When carrying out the comminuting operation of the material to be comminuted, by virtue of the process heat, the temperature of the comminuted material without cooling increases to T_{Output-Material}. In that respect the cooling capacity is to be provided by the coolant:

\dot{Q}_{Material}=\dot{m}_{Material}*C_{pMaterial}*(T_{Output-Material}−T_{Input-Material})

wherein dQ_{Material}/dt is the heating capacity introduced into the comminuted material, dm_{Material}/dt is the mass throughput of the comminution material and C_{P Material} is the specific heat of the comminution material. In the ideal case being considered 100% of the heating capacity introduced into the comminution material during the comminuting process is compensated upon the transition into the vaporous phase, utilizing the latent heat of the coolant. For the consideration hereinafter, pure water is supplied as the coolant, at a temperature Ta, so that the specific amount of heat in respect of that coolant is:

q_{water}=(4.18 kJ/*K))*(100−Tₐ)K+2246 kJ/kg.

In the case of an introduction temperature Ta by way of example of 15° of the water that involves a specific heat amount of:

q_{water}=2602.15 kJ/kg.

In that respect when using pure water as the coolant cooling by the occurrence of the latent heat makes up more than 86% in the described example.

The foregoing considerations lead to the equation:

dm_{water}/dt*q_{water}=dQ_{Material}/dt,

whereby the introduction rate for the coolant for the ideal situation being considered here can be determined, in respect of which it is assumed that the entire coolant introduced into the comminuting process changes to the vaporous phase.

It can be seen that the rate of introduction of the coolant into the comminuting process is dependent on the physical properties of the respective comminution material, in particular the specific thermal capacity, a transition temperature or a spontaneous combustion temperature and in that respect is to be matched to the respective material.

With the method according to the invention a temperature of the comminuted material can be measured and closed-loop controlled to a predetermined set point temperature or a set point temperature range of the comminuted material with a setting variable establishing the coolant introduction rate. Such a set point temperature can be for example below a melting temperature which has to be avoided depending on the respective application in the comminuting process in order for example not to hamper a subsequent further processing operation. By way of example an actual temperature of the comminuted material can be measured and, when a predetermined temperature threshold is exceeded, the coolant introduction rate can be increased, in which case preferably it is controlled to a predetermined set point temperature, with a setting variable establishing the coolant introduction rate, for example a signal for operation of a coolant pump or a coolant valve. Desirably, in carrying out the method according to the invention, the rate of introduction of the coolant is detected, for example by measuring the mass or volume throughput of the coolant, from which the introduction rate can be determined and in particular can be calculated.

It can be provided that a temperature at the rotor, in particular a temperature in the region of one or more comminuting tools, is to be measured, and closed-loop controlled to a predetermined set point temperature or a set point temperature range of the rotor with a setting variable which establishes the coolant introduction rate. It can also be provided that both a temperature of the rotor and also a temperature of the comminuted material is to be used as a closed-loop control variable with the introduction rate as a setting variable. In order to prevent a moisture content which is not conducive to further processing of the comminuted material, when carrying out the method according to the invention, it can be provided that a moisture content of the comminuted material is measured and controlled to a predetermined set point moisture content or a set point moisture content range of the comminuted material with a setting variable establishing the coolant introduction rate. In that respect it may also be desirable to measure the moisture content of the material to be comminuted, that is to say before the comminuting process, in which case that measurement is also involved in the described closed-loop control procedure.

In order to provide both temperature closed-loop control and also closed-loop control of the moisture content of the comminuted material it can be provided that in the method according to the invention both the temperature and also the moisture content of the comminuted material are involved as closed-loop variables and thus closed-loop control is in the form of multi-variable closed-loop control and the respective set point value or set point value range of the comminuted material is controlled with a setting variable establishing the coolant introduction rate. In particular it can be provided that the closed-loop control section has a decoupling controller.

In order to provide that the introduction of the coolant into the comminuting chamber or the comminuting process which takes place in the majority of design configurations in the region of the comminuting rotor is as homogenous as possible it can be provided that introduction of the coolant is effected by way of a multiplicity of locations spaced relative to the longitudinal axis of the rotor, at which nozzles or nozzle devices can be arranged. It can also be provided that the coolant is introduced by way of nozzle devices mounted or provided directly at the rotor. In this embodiment the rotor in that respect can include at least one coolant feed conduit for guiding coolant to the nozzle devices.

For more accurate closed-loop control of the method according to the invention it can be provided that a respective temperature of the or in the comminuted material is detected by means of a multiplicity of mutually spaced temperature sensors and the closed-loop control is carried out in dependence on the multiplicity of temperatures detected by the temperature sensors. In the same way a multiplicity of mutually spaced moisture sensors can detect a respective moisture content in the comminuted material and the closed-loop control operation can be carried out in dependence on the multiplicity of moisture contents detected by the moisture sensors.

In order to provide that the coolant introduction into the comminuting process is as uniform as possible it can be provided that the coolant is applied to the rotating rotor and/or to the material to be comminuted, in particular in the region of the rotor. In particular in the case of such comminuting apparatuses in which the comminuting tools arranged on the rotor co-operate with associated counterpart blades stationarily mounted to the machine frame it can also be provided that coolant is introduced in the region of the counterpart blades or the counterpart blade into the comminuting chamber or the comminuting process.

Depending on the respective arrangement of at least one nozzle of a nozzle device for introduction of the coolant it can be provided to increase the surface area of the coolant and thus to improve the level of cooling efficiency that the coolant is introduced into the comminuting process in the form of a water mist, in respect of which the water mist droplets are of a diameter <100 μm, in particular <50 μm.

In the method according to the invention the coolant introduction rate can be set as a setting variable of the closed-loop control procedure in particular by means of actuating signals for a coolant valve device and/or by means of actuating signals for a coolant pump.

As stated in the opening part of this specification the method according to the invention and the apparatus according to the invention also have the advantage over conventional apparatuses that the heated coolant generally does not have to be removed from the comminuted material. In order to avoid unacceptable air humidity in the working environment of the comminuting apparatus it can desirably be provided that the vapor substance which is developed during cooling of the comminuting process, in particular water vapor, is at least partially sucked away. Such vapor can be passed outwardly for example from the location of the comminuting apparatus and in the case of pure water vapor can be discharged in an environmentally acceptable fashion.

In an embodiment the quantitative throughput or mass flow or the volume flow of the material to be comminuted can be measured directly and can be involved in the closed-loop control according to the invention. It is however also possible to infer the quantitative throughput or mass or volume flow of the comminution material by way of the drive power of the motor driving the comminuting rotor so that the quantitative throughput of the comminution material can be indirectly detected by ascertaining the drive power, for adapting the coolant introduction rate.

With the closed-loop control procedures discussed in respect of the method according to the invention of cooling comminution material and/or comminuted material it is possible to correct for external influences on the comminuting process, for example stored heat from machine components and/or the environment, that can also change in the course of operation of the apparatus, so that those disturbance variables which are referred to by way of example and other disturbance variables which possibly occur and which have an effect on the comminuting process can be compensated.

For adaptation of the respective closed-loop controller to the specific closed-loop control section it is basically possible to use known controllers, for example PID or PI controllers. As illustrated those controllers can be for example in the form of single-point controllers, multi-point controllers, in particular two-point controllers, in order to reflect the respective time performance of the control section.

### BRIEF DESCRIPTION OF THE DRAWINGS

The invention is described in greater detail hereinafter by the description of some embodiments of the comminuting apparatus according to the invention and the method according to the invention with reference to the accompanying Figures in which:

FIG. 1a shows a view of a comminuting apparatus according to the invention,

FIG. 1b shows a diagrammatic functional view illustrating the structure of a comminuting apparatus according to the invention,

FIG. 2 shows a flow chart of the comminuting process of the comminuting apparatus of FIG. 1a, b,

FIG. 3 to describe the method according to the invention of cooling comminution material shows a block circuit diagram of a closed-loop control circuit for one-point control in carrying out the method according to the invention,

FIG. 4 shows a block circuit diagram of a further closed-loop control circuit with a two-point control for carrying out the method according to the invention,

FIG. 5 shows a block circuit diagram of a further closed-loop control circuit of a time control for carrying out the method according to the invention, and

FIG. 6 shows a block circuit diagram of a closed-loop control for carrying out the method according to the invention, in which a multiplicity of operating parameters are used to establish the closed-loop control, besides the reference and closed-loop variable.

### DETAILED DESCRTIPTION

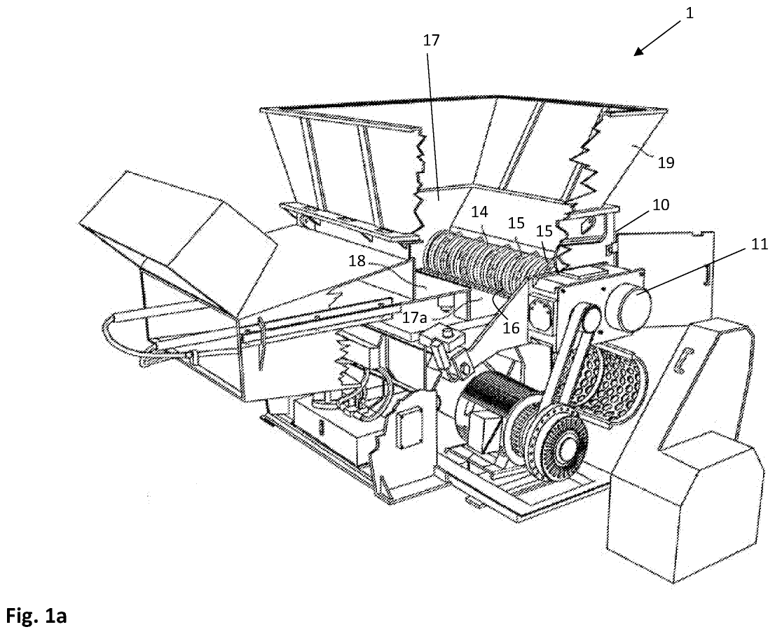

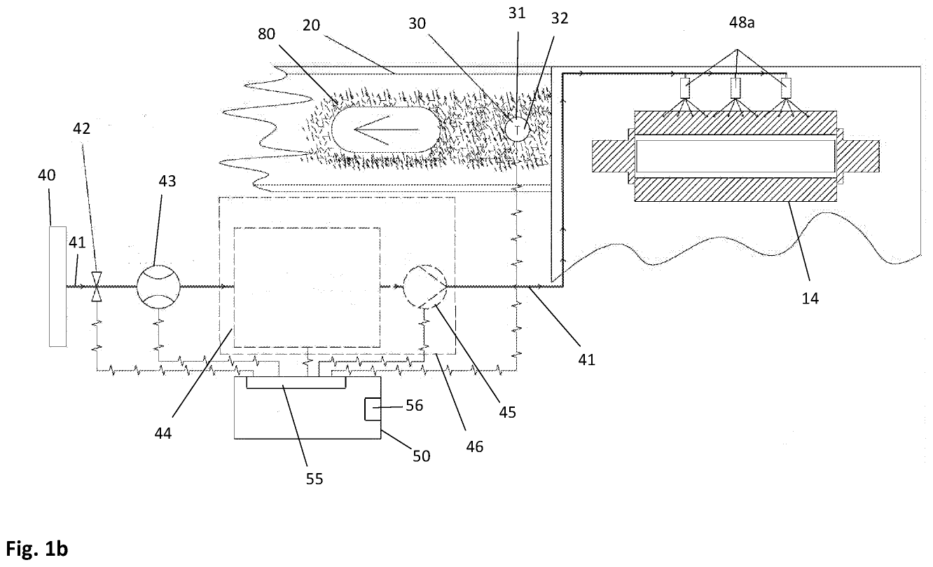

FIG. 1a shows a perspective view of a comminuting apparatus 1 designed according to the invention. A comminuting rotor 14 is mounted in the region of its two longitudinal ends to a machine housing 10, wherein the rotor 14 is moved by means of an electric drive motor 11 in the described embodiment.

In another embodiment it is also possible to use other drives, in particular hydraulic drives and/or drives including transmission devices for the movement of the comminuting rotor 14. At its periphery the comminuting rotor 14 has a plurality of comminuting tools 15 which co-operate with a counterpart blade arrangement 16 disposed stationarily relative to the machine housing 10 during the comminuting operation, for comminuting the comminution material. In the comminuting apparatus shown in Figure la the comminution material is introduced from above into the opening of a hopper 19 connected to the housing and then drops into the comminuting chamber which is delimited downwardly by the bottom and the comminuting rotor 14. In terms of understanding the present invention the comminuting rotor delimits that comminuting chamber but is part thereof. In the illustrated embodiment the comminuting apparatus can be arranged on a frame above a conveyor belt so that the comminuted material drops on to the conveyor belt which is disposed beneath the comminuting rotor, and can be received and transported away by same.

To describe a configuration according to the invention of the comminuting apparatus shown by way of example in FIG. 1a reference is now made to FIG. 1b which in relation to the invention shows functional regions of a comminuting apparatus according to the invention. In the described embodiment the comminution material introduced into the comminuting chamber is comminuted by the rotor 14. The comminuted material or ground material then here falls on to a conveyor belt 20 which is arranged beneath the rotor 14 and with which the ground material is transported for example into a storage arrangement. For detecting the state of the ground material sensors, in particular optical sensors, can be provided in the region directly beneath the rotor in order to detect the actual value of the temperature and the moisture content of the ground material. For that purpose, the arrangement has the temperature sensor 30 and the moisture content sensor 31. FIG. 1b diagrammatically also shows a mass sensor 32 adapted to detect the mass flow of the ground material.

In order to cool the material to be comminuted or the ground material the comminuting apparatus 1 according to the invention has a cooling device which includes a plurality of structural components, which are different depending on the respective design configuration involved, for constituting the coolant device. FIG. 1b simultaneously functionally shows two variants of a cooling device relating to the configuration of the comminuting apparatus according to the invention, in which respect the elements disposed in the rectangle identified by reference 46 are initially insignificant for an embodiment. According to the invention cooling is effected here with a liquid water-based coolant, wherein the coolant in the described embodiments has a water content of 100%. In that respect cooling is effected by the use of pure water so that the cooling device can be connected directly by means of a conventional water connection 40 to a conventional water supply mains. In the first-described embodiment the feed flow of the coolant can be set by way of a two-way valve 42 and the volume flow of the coolant or the water can be detected by way of a volume flow measuring device 43. The coolant is passed by way of a conduit 41 to nozzles 48b arranged in the region of the rotor of a nozzle device 48, by way of which the coolant depending on the respective embodiment is introduced for example directly on to the rotor and/or into the comminuting chamber. To ensure that the coolant is introduced as homogeneously and uniformly as possible the cooling nozzle device 48 can include nozzles 48b arranged in spaced relationship in the longitudinal direction relative to the rotor in order to introduce the coolant over the entire working width of the rotor corresponding to its axial working length. To enhance the interaction of the coolant with the material in the comminuting chamber, that is to say the material to be comminuted and the partially or completely comminuted material, it can be provided that specific nozzles, here water nozzles, are used, which are adapted to create a fine water mist, wherein individual droplets are of a diameter of <100 μm or even <50 μm depending on the respective design structure.

In particular in such cases in which the water pressure of the water supply is not sufficient to feed the nozzle device with cooling water at the respectively required pressure it can be provided that further structural elements are incorporated into the cooling device, which are shown in the broken-line region 46 in FIG. 1b. This concerns a water tank 44 which is connected to the water supply by means of the water connection 40 and has a filling level monitoring means, to which at the outlet side there is connected a pump 45 which here is further adapted for volume flow measurement of the volume flow delivered by the pump in the direction to the nozzles 48b.

Control of the cooling device is effected in the described embodiment by means of a control device 55 which can be arranged together with the control device 56 of the comminuting rotor, that is to say the control for controlling the rotor drive, in a control cabinet 50. In that respect the control devices 55, 56 can be coupled or can be combined together in a central control in order to couple the comminuting process to the cooling process or to use operating parameters of the comminuting process, for example information about the drive power which depends on the material flow of the material to be comminuted through the rotor, for open-loop or closed-loop control of the cooling device. In a similar manner cooling operating parameters can be forwarded by the control of the cooling device to the control of the rotor or the rotor drive in order to adapt the comminuting action to the operation of the cooling device.

The conduits shown in FIG. 1b of the valve device 42 and the volume flow measuring device 43, the water tank 44, the pump 45 and the sensors 30, 31, 32 to the control 55 of the cooling device can be adapted depending on the respective application both for the communication of control signals and also data signals, under some circumstances also bidirectionally.

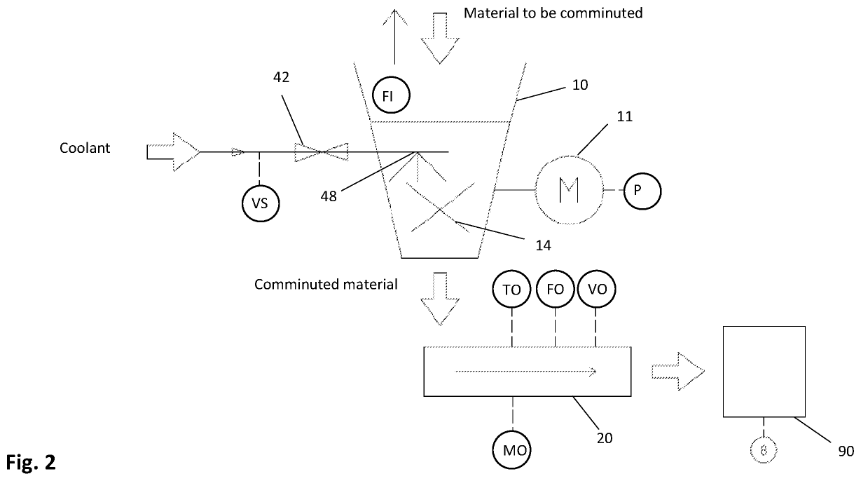

FIG. 2 shows the view of FIG. 1b with a higher degree of abstraction in the manner of a flow chart, wherein relevant operating parameters and measurement variables are specified for the embodiment of the method according to the invention and the apparatus according to the invention. The material to be comminuted which is introduced into the comminuting chamber of the machine housing 10 has a moisture content FI. It is comminuted by means of the comminuting rotor 14, wherein the drive motor 11 of the comminuting rotor uses an electric drive power P. The material comminuted by the rotor (ground material) drops on to the conveyor belt 20 at which or in the region of which respective sensor devices are disposed for detecting the temperature TO of the comminuted material (output material), the moisture content FO of the output material, the volume flow VO of the output material and/or the mass flow MO of the output material. The ground material which is transported away from the comminuting apparatus can be passed for example into a store 90. The feed of coolant is effected with a volume flow VS, wherein in this embodiment the discharge of coolant by way of a nozzle device 48 is controlled by means of the valve device 42.

The process control is not specified in the flow chart in FIG. 2, by definition. The described cooling of the material to be comminuted or of partially comminuted material in the comminuting chamber is effected to avoid elevated temperatures of the comminution material. For that purpose it can be provided that the apparatus according to the invention is designed and adapted to carry out a method in which the comminution material, that is to say the material to be comminuted, the partially comminuted material and/or the comminuted material, is cooled by means of a liquid water-based coolant, wherein an introduction rate, for example a volume flow or a mass flow of the coolant, into the comminuting process or the comminuting chamber, is adapted to an operating parameter of the comminuting apparatus, that is dependent on the quantitative throughput of the comminution material, like a volume throughput of the comminution material, a mass throughput of the comminution material and/or a drive power output of the comminuting rotor drive. According to the invention that adaptation is effected in such a way that more than 60% of the cooling capacity introduced into the comminution material is provided by the latent heat of the liquid coolant. Depending on the specific configuration of the method according to the invention the percentage proportion of the latent heat in relation to the total cooling capacity can also be set to be greater, for example more than 70% or more than 80% of the cooling capacity.

In then event of complete conversion of the heat capacity of the material dQ_{MATERIAL}/dt into the cooling capacity of the coolant with complete transition of the coolant into the vaporous phase the foregoing formula for the mass introduction rate dm_{WATER}/dt=(dQ_{MATERIAL}/dt)* 1/q_{WATER} or the volume introduction rate VS=dV_{WATER}/dt=(dm_{WATER}/dt)*(1/q_{WATER}), wherein q_{WATER} specifies the density of the coolant, here water. According to the invention adjustment is effected in dependence on the respective configuration involved by way of open-loop control or closed-loop control of the coolant introduction rate VS in the described fashion, wherein the introduction rate is reduced in accordance with the specified instruction if less than 60% of the cooling capacity introduced into the comminution material is provided by the latent heat of the coolant. The fact of the threshold being exceeded in that way can be detected for example by the moisture content FO of the comminuted material displaying a corresponding increased value, equivalent to the fact that the cooling capacity is provided to a lesser percentage by the latent heat of the coolant. Depending on the respective embodiment involved it can for example also be provided that suitable closed-loop or open-loop control is implemented in such a way that adaptation of the coolant introduction rate to the quantitative throughput of the comminution material into the comminuting process is carried out in such a way that more than 70%, more than 80%, in particular more than 90% of the coolant introduced transitions into the vaporous phase during the cooling process. If that percentage is not reached, which can be detected for example by measuring an increased moisture content in the comminuted material, it is possible in accordance with the invention in this embodiment to reduce the coolant introduction rate VS.

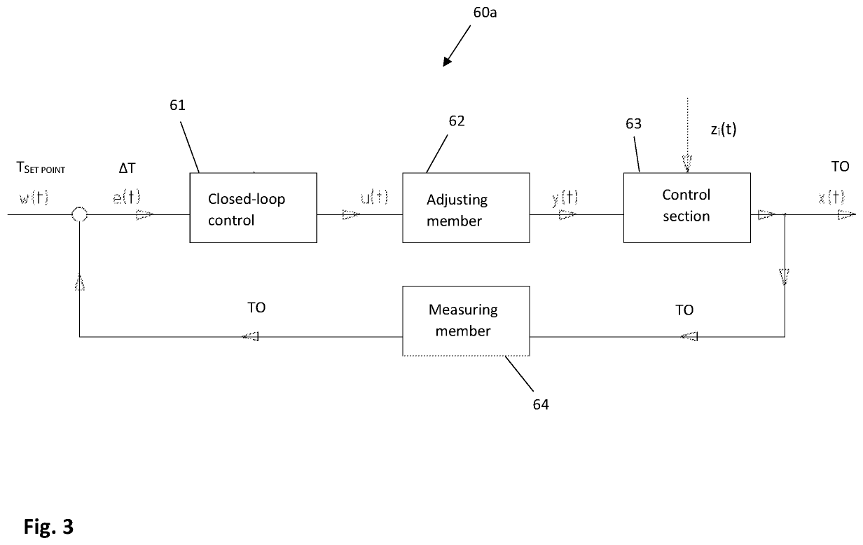

It can be provided that, in the method according to the invention or the comminuting apparatus according to the invention, cooling of the comminution material is subjected to closed-loop control. For example, in an embodiment a temperature of the comminuted material can be measured and subjected to closed-loop control to a predetermined set point temperature of the comminuted material with a setting variable establishing the coolant introduction rate, insofar as the temperature of the comminuted material represents the closed-loop control variable. FIG. 3 shows a corresponding closed-loop control circuit 60 for carrying out an embodiment of the invention for such a closed-loop control, wherein a temperature T_{SET POINT} which is predetermined and generally dependent on the respective comminution material is implemented as the reference variable. In the described embodiment the closed-loop controller 61 is in the form of a PI or PID closed-loop controller. It outputs an actuating signal u(t) for actuation of a setting member 62 which sets the setting variable volume flow VS of the coolant. In that respect the valve device 42 in FIG. 2 corresponds to the setting member 62. The setting variable y(t) corresponds to that volume flow VS of the coolant. The closed-loop control section 63 corresponds to the installation part of the comminuting apparatus according to the invention between the location of the setting member 62 and the measuring member 64, that is to say in the FIG. 2 embodiment the valve device 42, and the temperature sensor for detecting the temperature TO of the comminuted material. An appropriate configuration of the closed-loop control variable also takes account of the action of disturbance variables zi(t), for example the heat stored in the machine components and/or the ambient temperature as well as further external effects which have an effect on the comminuting process and/or the cooling process. The resulting temperature TO of the comminuted material is detected by way of the measuring member 64 and fed back for comparison with the reference variable w(t) (set point temperature) and for ascertaining the control deviation e(t), here ΔT=T_{SET POINT}−TO.

In a further embodiment it can also be provided in relation to the method of FIG. 3 that a predetermined moisture content FO-set point is to be predetermined as the reference variable of the closed-loop control, wherein the closed-loop control circuit can be designed corresponding to the circuit shown in FIG. 3, that is to say the closed-loop control circuit is implemented in the form of a one-point control for control of a predetermined moisture content of the output material, wherein again the introduction rate or the volume flow VS of the coolant functions as the setting variable and the moisture content of the output material represents the closed-loop control variable.

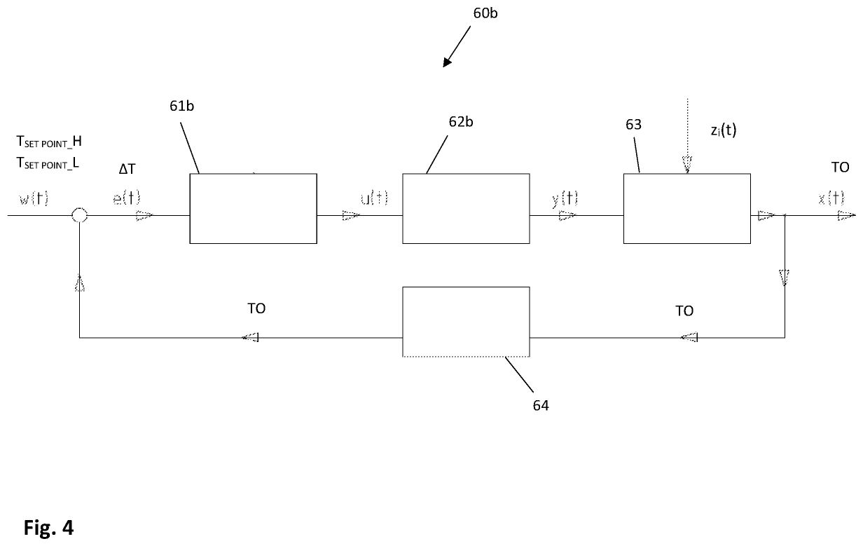

FIG. 4 shows a further embodiment for implementation of the method according to the invention, in which the closed-loop control circuit 60b implements two-point control, in which the valve device represents a setting member 63b which is in the form of a two/two-way valve. In that respect the setting member 63b sets the volume flow of the coolant in such a way that the temperature TO of the output material remains between a temperature upper limit T_{SET POINT}_H and a temperature lower limit T_{SET POINT}_L. While the controllers 61a, b and the setting members 62a, b of the method in FIGS. 3 and 4 differ the control section 63 is identical insofar as there are no further installation-specific modifications.

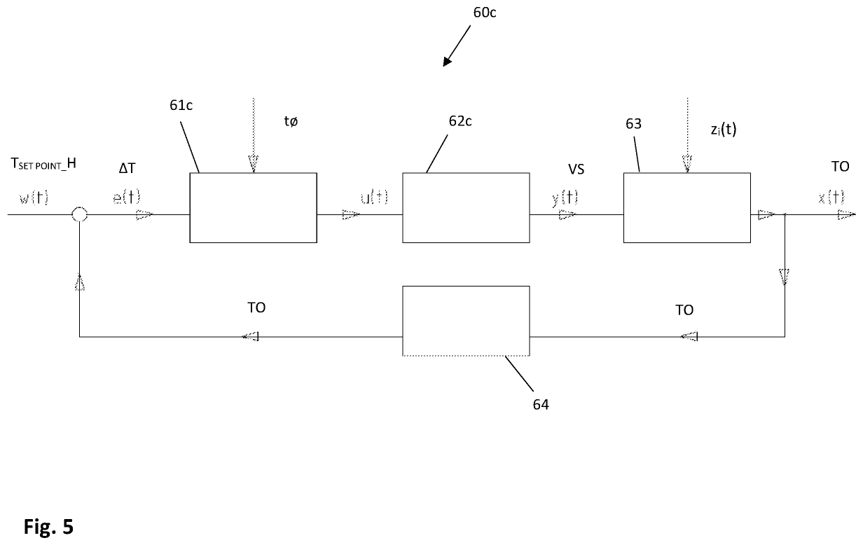

FIG. 5 shows a further closed-loop control circuit for implementing the method according to the invention, in which a predetermined period of time t0 is applied to the controller 61c as a further process variable, a maximum allowed temperature of the comminuted material T_{SET POINT}_H is predetermined as a reference variable and the actual temperature TO is again detected by way of the measuring member 64. Closed-loop control with the actual temperature TO of the comminuted material as the closed-loop control variable is effected here by a suitable configuration of the controller 61c in such a way that the setting member 62c which is again in the form of a two/two-way valve sets the volume flow of the coolant in such a way that, upon attainment of the temperature upper limit T_{SET POINT}_H over a period of time tO coolant is fed to the comminuting process and thus heating capacity is removed.

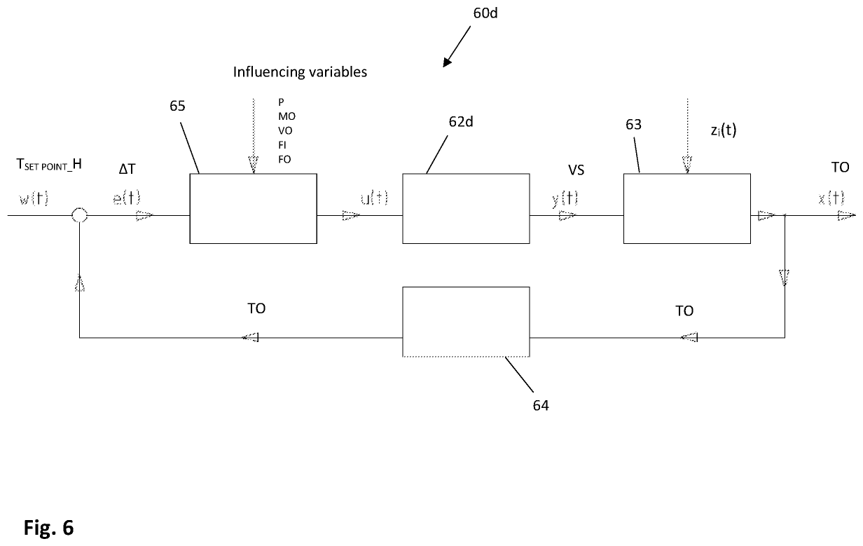

FIG. 6 shows a further closed-loop control circuit for implementation of the method according to the invention, in which a maximum temperature of the comminuted material T_{SET POINT}_H is used as the reference variable and the temperature TO of comminuted material is used as the closed-loop control variable. Unlike the method with the closed-loop control circuit of FIG. 3 the control circuit has a controller 65 which can involve both the closed-loop control deviation ΔT and also operating parameters or measurement variables of the apparatus as input variables, like for example the drive power P, the mass flow MO and the volume flow VO of the comminuted material, the moisture content FI of the material to be comminuted and/or the moisture content FO of the comminuted material. Therefrom the closed-loop controller 65 ascertains an actuating signal u(t) with which the setting member 62, for example a valve device for setting a coolant flow, is actuated. In that way for example in the event of control of the temperature TO of the ground material it is possible to intervene by the control device 65 if the moisture content FO of the ground material attains inadmissible values. For that purpose, the controller 65 can be adapted to deliver an output signal u(t) which serves as a control signal for the setting member in order to actuate same to reduce the coolant introduction rate. For example, a signal for displaying the direction of rotation of the comminuting rotor can serve as further input variables of the controller 65. In that way the closed-loop controller 65 can be adapted to reduce the coolant introduction rate or to set it to zero if that display signal displays reverse rotation of the comminuting means.

### LIST OF REFERENCES

1 comminuting apparatus
10 machine housing, machine frame
11 drive motor
14 comminuting rotor, rotor
15 comminuting tools
16 counterpart blade
17 comminuting chamber
17a bottom of comminuting chamber
18 feed device
19 hopper
20 conveyor belt
30 temperature sensor
31 moisture content sensor, moisture sensor
32 mass sensor
40 water connection
41 water conduit
42 valve, valve device
43 water-volume flow measuring device
44 water tank with filling level monitoring
45 water pump, coolant pump
48 nozzle device
48a water nozzle, nozzle
50 control cabinet
55 control device of the cooling device
56 control device of the comminuting rotor
60 control circuit
61 closed-loop controller
62 setting member
63 closed-loop control section
64 measuring member
80 comminuted material/ground material
90 mounting
TO temperature of the comminuted material (output)
VS introduction rate, volume flow of the coolant
FI moisture content of the material to be comminuted (input material)
P electric drive power of the rotor drive
FO moisture content of the output material
VO volume flow of the output material
MO mass flow of the output material
w(t) reference variable
T_{SET POINT} set point temperature
X(t) closed-loop control variable
u(t) actuating signal of the setting member
y(t) setting variable
z(t) disturbance variable
e(t) closed-loop control deviation

### K710622US

What is claimed is:

1-28. (canceled)

29. A comminuting apparatus to carry out a comminuting process, the apparatus comprising:
a comminuting rotor mounted to a machine frame and which has a plurality of comminuting tools at a periphery,
wherein the comminuting rotor is arranged in a comminuting chamber to receive comminution material, and is adapted to comminute the material in the comminuting chamber,
a cooling device to introduce a liquid coolant having at least 80% water by weight into the comminuting chamber,
a control device to control the cooling device to set a rate of introduction of the coolant into the comminuting chamber, and
wherein the control device is configured to adapt a rate of introduction of the liquid water-based coolant into the comminuting process to an operating parameter of the apparatus, that is dependent on a quantitative throughput of the comminution material, in particular a volume throughput, a mass throughput of the comminution material, and/or a drive power of a rotor drive such that more than 60% a cooling capacity introduced into the comminution material is provided by latent heat of the liquid water-based coolant.

30. The comminuting apparatus as set forth in claim 29, wherein the control device is configured to implement adaptation of the rate of introduction of the coolant to the quantitative throughput of the comminution material into the comminuting process such that more than 80% of the coolant introduced upon cooling of the comminution material changes from liquid to vaporous phase.

31. The comminuting apparatus as set forth in claim 29, wherein the cooling device includes a connecting device to connect to a coolant conduit network and/or to connect to a coolant reservoir, and a coolant nozzle device to introduce the coolant into the comminuting process or the comminuting chamber,
wherein the control device to control the rate of introduction of the coolant into the comminuting chamber controls at least one valve device of the coolant and/or at least one coolant pump.

32. The comminuting apparatus as set forth in claim 31, wherein the coolant nozzle device is adapted to apply the coolant to the rotor and/or the material to be comminuted.

33. The comminuting apparatus as set forth in claim 31, wherein the coolant nozzle device is adapted to introduce the coolant in a form of a mist into the comminuting process,
wherein mist droplets of the coolant are of a diameter <100 μm.

34. The comminuting apparatus as set forth in claim 31, wherein the coolant nozzle device has a plurality of nozzles arranged in spaced relationship with a longitudinal axis of the rotor on the machine frame of the comminuting machine and which are arranged above the rotor in an installed position to introduce the coolant.

35. The comminuting apparatus as set forth in claim 31, wherein the coolant nozzle device has a plurality of nozzles arranged in spaced relationship with a longitudinal axis of the rotor at the periphery thereof.

36. The comminuting apparatus as set forth in claim 29, further comprising:
at least one temperature sensor to detect a temperature of the comminuted material,
wherein the control device is adapted to provide for closed-loop control to a predetermined set point temperature or a predetermined set point temperature range of the comminuted material with a setting variable establishing the rate of introduction of the coolant.

37. The comminuting apparatus as set forth in claim 29, further comprising:
at least one temperature sensor to detect a temperature at the rotor,
wherein the control device is adapted to provide for closed-loop control to a predetermined set point temperature or a predetermined set point temperature range of the rotor with a setting variable establishing the rate of introduction of the coolant.

38. The comminuting apparatus as set forth in claim 29, further comprising:
at least one moisture sensor to detect a moisture content of the comminuted material,
wherein the control device is adapted to provide for closed-loop control to a predetermined set point moisture content or a predetermined set point moisture content range of the comminuted material with a setting variable establishing the rate of introduction of the coolant.

39. The comminuting apparatus as set forth in claim 38, wherein the closed-loop control includes temperature and the moisture content of the comminuted material as closed loop control variables, and is designed as multi-variable closed-loop control and the respective set point value or set point range of the comminuted material are subjected to closed-loop control with a setting variable establishing the rate of introduction of the coolant.

40. The comminuting apparatus as set forth in claim 29, further comprising:
a plurality of mutually spaced temperature sensors to detect a respective temperature in the comminuted material,
wherein closed-loop control is carried out in dependence on the respective temperatures detected by the temperature sensors.

41. A comminuting apparatus as set forth in claim 29, further comprising:
an extraction device adapted for at least partially suck away water vapor which develops during cooling of the material to be comminuted.

42. The comminuting apparatus as set forth in claim 29, further comprising:
at least one moisture sensor to measure a moisture content of the material to be comminuted, and the rate of introduction of the coolant is adjusted in dependence thereon as a control variable.

43. A method of cooling comminution material in a comminuting apparatus to carry out a comminuting process, comprising:
disposing a comminution material in a comminuting chamber of the comminuting apparatus,
comminuting the comminution material with comminuting tools mounted at a periphery of a comminuting rotor,
during comminuting of the comminution material, introducing a liquid coolant having at least 80% water into the comminuting chamber, and
adapting a rate of introduction of the liquid water-based coolant into the comminuting process to an operating parameter of the apparatus, that is dependent on a quantitative throughput of the comminution material, in particular a volume throughput, a mass throughput of the comminution material, and/or a drive power of a rotor drive such that more than 60% of a cooling capacity introduced into the comminution material is provided by latent heat of the liquid water-based coolant.

44. The method as set forth in claim 43, wherein adaptation of the rate of introduction of the coolant to the quantitative throughput of the comminution material into the comminuting process is carried out such that more than 80% of the coolant introduced upon cooling of the comminution material changes from liquid to vaporous phase.

45. The method as set forth in claim 43, further comprising:
measuring a temperature of the comminuted material, and
subjecting the temperature to closed-loop control to a predetermined set point temperature or a set point temperature range of the comminuted material with a setting variable establishing the rate of introduction of the coolant.

46. The method as set forth in claim 45, further comprising:
detecting a respective temperature of the comminuted material by a plurality of mutually spaced temperature sensors, and the closed-loop control is carried out in dependence on the respective temperatures detected by the temperature sensors.

47. The method as set forth in claim 43, further comprising:
measuring a temperature of the rotor, and
subjecting the temperature to closed-loop control to a predetermined set point temperature or a set point temperature range of the rotor with a setting variable establishing the rate of introduction of the coolant.

48. The method as set forth in claim 43, further comprising:
measuring a moisture content of the comminuted material, and
subjecting the moisture content to closed-loop control to a predetermined set point moisture content or a set point moisture range of the comminuted material with a setting variable establishing the rate of introduction of the coolant.

49. The method as set forth in claim 48, wherein the closed-loop control includes temperature and the moisture content of the comminuted material as closed loop control variables, and is designed as multi-variable closed-loop control and the respective set point value or set point range of the comminuted material are subjected to closed-loop control with a setting variable establishing the rate of introduction of the coolant.

50. The method as set forth in claim 43, wherein introduction of the coolant is carried out by way of a plurality of nozzles arranged in spaced relationship with the longitudinal axis of the rotor on a machine frame of the comminuting machine and above the rotor in the installed position.

51. The method as set forth in claim 43, wherein introduction of the coolant is carried out by a plurality of nozzles arranged in spaced relationship with a longitudinal axis of the rotor at the periphery thereof.

52. The method as set forth in claim 43, further comprising:
applying the coolant to the rotor and/or to the material to be comminuted.

53. The method as set forth in claim 43, wherein the coolant is introduced in a form of a mist into the comminuting process,
wherein mist droplets of the coolant are of a diameter <100 μm.

54. The method as set forth in claim 43, wherein the rate of introduction of the coolant is set as a setting variable of the closed-loop control by a coolant valve device.

55. The method as set forth in claim 43, further comprising:
at least partially sucking away water vapor which develops during cooling of the comminuted material.

56. The method as set forth in claim 43, further comprising:
measuring a moisture content of the material to be comminuted, and
the rate of introduction of the coolant subjected to closed-loop control in dependence thereon as a control variable.
